(19) United States
(12) Patent Application Publication
(10) Pub. No.: US 2024/0191025 A1
(43) Pub. Date: Jun. 13, 2024

(54) NOVEL POLYETHERS ON THE BASIS OF 2,3-EPOXYBUTANE AND PROCESS FOR THE PREPARATION THEREOF

(71) Applicant: Evonik Operations GmbH, Essen (DE)

(72) Inventors: Frank Schubert, Neukirchen-Vluyn (DE); Sarah Otto, Essen (DE); Daniela Hermann, Duesseldorf (DE); Heike Hahn, Bochum (DE)

(73) Assignee: Evonik Operations GmbH, Essen (DE)

(21) Appl. No.: 18/552,421

(22) PCT Filed: Mar. 14, 2022
(86) PCT No.: PCT/EP2022/056440

§ 371 Date: Sep. 25, 2023

(30) Foreign Application Priority Data
Mar. 26, 2021 (EP) 21165089.0

(51) Int. Cl. C08G 65/26

(52) U.S. Cl. CPC C08G 65/2609; C08G 65/2663; C08G 65/2696; C08G 2650/04

(57) ABSTRACT

A process for preparing polyethers based on cis-2,3-epoxybutane and trans-2,3-epoxybutane, involves reacting at least one starter compound (A) in the presence of a double metal cyanide catalyst (B), with 2,3-epoxybutane (C) and optionally further epoxy monomers (D), to afford at least one polyether (E). The process also optionally involves reacting the at least one polyether (E) with at least one end-capping reagent (F), to afford at least one end-capped polyether (G).

The invention relates to an alkoxylation process for preparing novel polyethers based on 2,3-epoxybutane and to the polyethers preparable by this process.

Conventional polyether alcohols, often referred to simply as polyethers for short, are mainly prepared in an alkoxylation reaction of propylene oxide and ethylene oxide and have long been known. Far less widespread is the use of other epoxy monomers such as 1,2-butylene oxide, isobutylene oxide, styrene oxide, 1,2-octene oxide, 1,2-decene oxide, 1,2-dodecene oxide or e.g. cyclohexene oxide.

Most processes for preparing alkoxylation products (polyethers) employ basic catalysts such as alkali metal hydroxides and alkali metal alkoxides, in specific cases also amines and guanidines. Less commonly, acid catalysts such as mineral acids and Lewis acids are used. In addition, double metal cyanide catalysts (DMC catalysts) have in recent years become increasingly important. This is the case in particular for DMC catalysts containing zinc and cobalt for the preparation of polypropylene glycols.

The nature of the monomers used in the alkoxylation reaction and of the chain starter, the copolymerization of different epoxy monomers, and the choice of catalyst in the alkoxylation reaction are of critical importance for the chemical composition and the use properties of the alkoxylation end products. The catalysis/reaction conditions in the alkoxylation are guided by the choice of chain starter and monomers in the individual case and e.g. by the desired molar mass and product purity. The relationships are described in the literature and are known to those skilled in the art.

Relatively little is however known about the alkoxylation of cis-2,3-epoxybutane (cis-2-butylene oxide) and trans-2,3-epoxybutane (trans-2-butylene oxide). There are pointers in the literature that the preparation of polyethers based on 2,3-epoxybutane as monomer is not at all trivial and that special catalytic processes and reaction conditions are necessary in order to prepare products reproducibly and in acceptable quality.

GB 1147791 discloses the preparation of semicrystalline polyethers by an acid-catalysed homopolymerization of trans-2,3-epoxybutane at low temperatures of −10° C. to 30° C. in CH₂Cl₂. Crystalline poly(trans-2,3-epoxybutane) is according to U.S. Pat. No. 3,356,620 obtained using a trialkylaluminium catalyst at 0° C. in toluene.

In the process described in document U.S. Pat. No. 3,065,187, poly(trans-2,3-epoxybutane) and poly(cis-2,3-epoxybutane) are prepared by an alkoxylation of isomerically pure 2,3-epoxybutanes in the presence of dialkylaluminium halides and dialkylaluminium alkoxides at 30° C. in diethyl ether. It should be noted that the polyethers have different properties depending on the 2,3-epoxybutane isomer. The crystalline products have different melting points and solubility properties. In order to obtain crystalline polyethers, the use of isomerically pure cis- or trans-2,3-epoxybutane is recommended. Organoaluminium catalysts for the alkoxylation of 2,3-epoxybutane are also used in U.S. Pat. No. 3,280,045.

Inoue (ACS Symposium Series (1992), 496 (Catal. Polym. Synth.), 194-204) and Watanabe (Macromolecules (1992), 25(5), 1396-400) describe the polymerization of 2,3-epoxybutane using Zn-tetraphenylporphyrin catalysts, while lijima (Journal of Polymer Science, Part A: Polymer Chemistry (1989), 27(11), 3651-8) uses alpha-methoxyphenylmethyl hexachloroantimonate to bring about the polymerization of cis- and trans-2,3-epoxybutane at −78° C. in CH₂Cl₂. The work of Vandenberg (Journal of Polymer Science (1960), 47, 489-91) demonstrates that, depending on the catalyst and on the 2,3-epoxybutane isomer, polyethers with very different physical properties such as e.g. crystallisation tendency, melting points and solubility behaviour are obtained.

US 20130248756 describes mixtures of polyethers and abrasive particles, in which the polyether is produced by DMC catalysis and has a block-type structure formed from an EO block and a 2,3-epoxybutane block. Starters cited include glycerol and sorbitol. In the process disclosed in U.S. Pat. No. 5,426,174, montmorillonite is used as catalyst for the alkoxylation of mixtures of 2,3-epoxybutane and 1,2-butylene oxide. DE 2246598 describes copolymers of 1-butylene oxide, propylene oxide and 2,3-epoxybutane prepared in an alkali-catalysed alkoxylation reaction and then coupled together via a Williamson etherification with CH₂Cl₂. In U.S. Pat. No. 3,272,889, cis-2,3-epoxybutane is polymerized with ethylene oxide in the presence of triethylaluminium. US 20120016048 includes natural-oil-based polyether polyols for PU foams that are prepared by DMC catalysis. 2,3-Epoxybutane is cited as a possible monomer. The process disclosed in WO 2011135027 relates to the DMC-catalysed preparation of polyols from fatty acid esters by an alkoxylation reaction of ethylene oxide with another alkylene oxide, e.g. 2,3-epoxybutane.

In US 20080021191, starter polyols such as glycerol and sorbitol are first acidified and then alkoxylated by DMC catalysis. Among the possible monomers that can be used is 2,3-epoxybutane. NL 6413172 includes PU foams obtained from polyols prepared by blockwise alkoxylation of ethylene oxide and other alkylene oxides having ≥3 carbon atoms. KOH is cited as catalyst.

From the prior art it can be inferred that the preparation of polyethers based on 2.3-epoxybutane requires special catalysts and processes. Organoaluminium catalysts are known to be sensitive to air and moisture ingress and are difficult to handle in an industrial setting. Many of the catalysts described above require low reaction temperatures and the preparation of polyethers is possible only in solvents. This too makes transfer to production scale problematic. Pure homopolymers of cis-2,3-epoxybutane and trans-2,3-epoxybutane are described as crystalline polyethers having melting points of 70° C. and higher.

If the alkoxylation of trans-2,3-epoxybutane takes place in the presence of strongly basic catalysts, this results in the formation, according to D. Hölting (dissertation “Kohlenstoffdioxid sowie 2,3-Butylenoxid-Derivate als Polymerbausteine” [Carbon dioxide and 2,3-butylene oxide derivatives as polymer building blocks], University of Hamburg, 2012), of unsaturated compounds arising through rearrangement reactions of the monomer and through elimination of water from the terminal tertiary hydroxyl group of the polyether chain. The elimination of water amounts to chain termination. At the same time, water can act as a chain starter for unwanted polyether diols. The preparation of high-molecular-weight polyethers based on trans-2,3-epoxybutane using conventional catalysts is therefore not possible. All of this means that the processes described in the prior art have various drawbacks.

The processes to date are often aimed at the preparation of solid, crystalline homopolymers of cis- or trans-2,3-epoxybutane. Only little has been published on the alkoxylation of cisitrans-isomer mixtures and the copolymerization thereof with other alkylene oxides such as ethylene oxide or propylene oxide. Polyethers prepared using DMC catalysis are restricted to a few selected starter compounds and derived target structures.

There is accordingly thus far no process for the alkoxylation of cis- and trans-2,3-epoxybutane that is easy to employ industrially, has adequate selectivity, and provides access to a wide structural diversity of polyethers based on 2,3-epoxybutane.

The object of the present invention was to overcome at least one disadvantage of the prior art and to provide an improved alkoxylation process for preparing polyethers based on 2,3-epoxybutane that can be applied on an industrial scale. A further object of the invention is to provide a new class of polyether structures based on 2,3-epoxybutane preparable by this process.

It has surprisingly now been found that 2,3-epoxybutane can be selectively alkoxylated in an advantageous and simple manner in the presence of known double metal cyanide catalysts, also known as DMC catalysts, in which the tendency to undesired side reactions (rearrangements, chain termination reactions, formation of unsaturated compounds) characteristic of these monomers can be largely avoided under the preferred reaction conditions.

Starting from a starter compound having a reactive hydrogen (also referred to as a chain starter or starter), the process of the invention provides for the first time a simple and reproducible means of homopolymerizing 2,3-epoxybutane and copolymerizing 2,3-epoxybutane with other epoxy compounds.

It has surprisingly now been found that the abovementioned object is achieved by an alkoxylation process for preparing polyethers based on cis-2,3-epoxybutane and trans-2,3-epoxybutane that comprises the following steps:
a) reacting at least one starter compound (A) in the presence of a double metal cyanide catalyst (B) with 2,3-epoxybutane (C) and optionally further epoxy monomers (D) to afford at least one polyether (E).

It is preferable that the process of the invention additionally includes the following step:
b) reacting the at least one polyether (E) with at least one endcapping reagent (F) to afford at least one endcapped polyether (G).

It has surprisingly additionally been found that especially isomer mixtures of cis-2,3-epoxybutane and trans-2,3-epoxybutane undergo a ring-opening alkoxylation in the presence of preferably zinc/cobalt double metal cyanide catalysts.

The process of the invention grants the synthetic freedom to alkoxylate desired cis/trans-2,3-epoxybutane mixtures alone (homopolymerizing) or in combination with other epoxy compounds (D), it being possible for the oxybutylene units resulting from opening of the epoxy ring to be present both terminally and as isolated units, cumulatively in block form, and also randomly interspersed in the polyoxyalkylene chain of the reaction product.

The object of the present invention is therefore achieved by the subject matter of the independent claims. Advantageous configurations of the invention are specified in the subordinate claims, the examples and the description.

### BRIEF DESCRIPTION OF THE FIGURES FIG. 1 and FIG. 2

FIG. 1 shows the GPC curve of a polyether (E) of the formula (2) based on cis/trans-2,3-epoxybutane and prepared by alkaline catalysis, as described in example 1 in the experimental section.

FIG. 2 shows the GPC curve of a polyether (E) of the formula (2) based on cis/trans-2,3-epoxybutane and prepared by DMC catalysis, as described in example 2 in the experimental section.

The plots in each case show the signal intensity (norm.) measured by the RI detector against the molar mass in daltons.

The subject matter of the invention is described by way of example below but without any intention that the invention be restricted to these illustrative embodiments. Where ranges, general formulas or classes of compounds are specified below, these are intended to encompass not only the corresponding ranges or groups of compounds that are explicitly mentioned but also all subranges and subgroups of compounds that can be obtained by removing individual values (ranges) or compounds. Where documents are cited in the context of the present description, the entire content thereof is intended to be part of the disclosure content of the present invention.

Where average values are stated hereinbelow, these values are numerical averages unless otherwise stated. Where measured values, parameters or material properties determined by measurement are stated hereinbelow, these are, unless otherwise stated, measured values, parameters or material properties measured at 25° C. and preferably at a pressure of 101 325 Pa (standard pressure).

In the context of the present invention, the number-average molar mass Mₙ, weight-average molar mass M_{w} and polydispersity (M_{w}/Mₙ) are preferably determined by gel-permeation chromatography (GPC), as described in the examples, unless explicitly stated otherwise.

Where numerical ranges in the form “X to Y” are stated hereinbelow, where X and Y represent the limits of the numerical range, this is synonymous with the statement “from at least X up to and including Y”, unless otherwise stated. Stated ranges thus include the range limits X and Y, unless otherwise stated.

Wherever molecules/molecule fragments have one or more stereocentres or can be differentiated into isomers on account of symmetries or can be differentiated into isomers on account of other effects, for example restricted rotation, all possible isomers are preferably encompassed by the present invention.

The formula (2) further below describes compounds or radicals that are constructed from repeat units, for example repeat fragments, blocks or monomer units, and can have a molar mass distribution. The frequency of the repeat units is stated in the form of indices. The indices used in the formulas should be regarded as statistical averages (numerical averages) unless explicitly stated otherwise. The indices used and also the value ranges of the stated indices should be regarded as averages of the possible statistical distribution of the structures that are actually present and/or mixtures thereof. The various fragments or repeat units of the compounds described in the formula (2) below may show a statistical distribution. Statistical distributions have a blockwise structure with any number of blocks and any sequence or are subject to a randomized distribution; they may also have an alternating structure or else form a gradient along the chain, where one is present; in particular they can also give rise to any mixed forms in which groups having different distributions may optionally follow one another. The formulas below include all permutations of repeat units.

Where, in the context of the present invention, compounds are described that can contain different units multiple times, then these can occur in said compounds in an unordered manner, for example in a random distribution, or in an ordered manner. The figures for the number or relative frequency of units in such compounds should be regarded as an average (numerical average) over all the corresponding compounds. Specific embodiments may lead to restrictions on statistical distributions as a result of the embodiment. For all regions unaffected by such restriction, the statistical distribution is unchanged.

The invention thus firstly provides a process for preparing polyethers based on cis-2,3-epoxybutane and trans-2,3-epoxybutane, comprising the steps of:
a) reacting at least one starter compound (A) in the presence of a double metal cyanide catalyst (B) with 2,3-epoxybutane (C) and optionally further epoxy monomers (D) to afford at least one polyether (E);
optionally b) reacting the at least one polyether (E) with at least one endcapping reagent (F) to afford at least one endcapped polyether (G).

### Starter Compound (A)

In the context of the present invention, starter compounds are understood to mean substances that form the start of the polyether to be prepared that is obtained by addition according to the invention of epoxy-functional monomers (C) and optionally further comonomers (D).

The starter compounds (A) used for the alkoxylation reaction may preferably be any compounds of the formula (1)

R(—OH)ₐ (1)

where
R is a saturated or unsaturated, linear or branched radical having 1 to 500 carbon atoms, preferably having 2 to 250 carbon atoms, more preferably having 3 to 100 carbon atoms, in which the carbon chain may be interrupted by heteroatoms such as oxygen, nitrogen or silicon,
a is an integer from 1 to 8, preferably from 1 to 6, more preferably from 1 to 4 and very particularly preferably from 1 to 3.

The starter compounds (A) may be used alone or in any desired mixtures and are preferably selected from the group of alcohols, polyetherols or phenols.

The OH-functional starter compounds of the formula (1) that are used are preferably compounds having molar masses of 30 to 15 000 g/mol, in particular 50 to 5000 g/mol.

Examples of compounds of the formula (1) are allyl alcohol, allyloxyethanol, allyloxypropanol, methallyl alcohol, butanol, 5-hexen-1-ol, hexanol, octanol, 3,5,5-trimethylhexanol, isononanol, decanol, dodecanol, tetradecanol, hexadecanol, stearyl alcohol, 2-ethylhexanol, cyclohexanol, benzyl alcohol, trimethylolpropane diallyl ether, trimethylolpropane monoallyl ether, glycerol diallyl ether, glycerol monoallyl ether, diethylene glycol monomethyl ether, diethylene glycol monobutyl ether, dipropylene glycol monomethyl ether, dipropylene glycol monobutyl ether, ethylene glycol, propylene glycol, di-, tri- and polyethylene glycol, 1,2-propylene glycol, di- and polypropylene glycol, butane-1,4-diol, hexane-1,6-diol, trimethylolpropane, glycerol, polyglycerol, pentaerythritol, sorbitol, and/or other hydroxyl-bearing compounds based on natural products. In addition to compounds having aliphatic and/or cycloaliphatic OH groups, any desired compounds having phenolic OH functions are suitable. These include by way of example phenol, alkyl- and arylphenols, bisphenol A and/or novolaks.

Preference may be given to using as the starter compounds (A) allyl alcohol, allyloxyethanol, allyloxypropanol, methallyl alcohol, butanol, fatty alcohols having 8 to 20 carbon atoms, dipropylene glycol, glycerol and/or polyetherols having 1-8 hydroxyl groups and molar masses of 50 to 5000 g/mol that had in turn been prepared by a prior alkoxylation.

### Double Metal Cyanide Catalyst (DMC catalyst) (B)

Preference is given to using zinc/cobalt DMC catalysts, in particular those containing zinc hexacyanocobaltate(III). Preference is given to using the DMC catalysts described in U.S. Pat. No. 5,158,922, US 20030119663, WO 01/80994. The catalysts may be amorphous or crystalline.

It is preferable that the catalyst concentration is from >0 ppmw to 1000 ppmw, more preferably from >0 ppmw to 700 ppmw, most preferably from >10 ppmw to 500 ppmw, based on the total mass of the products (E) formed. “ppmw” denotes parts per million by weight.

The catalyst is preferably metered into the reactor only once. The catalyst should preferably be clean, dry and free of basic impurities that could inhibit the DMC catalyst. The amount of catalyst should preferably be set so as to give sufficient catalytic activity for the process. The catalyst may be metered in in solid form or in the form of a catalyst suspension. If a suspension is used, then a particularly suitable suspension medium is the starter.

To start the DMC-catalysed reaction, it may be advantageous to first activate the catalyst with a portion of the at least one epoxy-functional compound (C) or (D), preferably selected from the group of the alkylene oxides, in particular with 2,3-epoxybutane, propylene oxide and/or ethylene oxide. Once the alkoxylation reaction has commenced, the continuous addition of the monomer may be begun.

The reaction temperature is preferably from 50° C. to 180° C., more preferably from 60° C. to 150° C. and most preferably from 80° C. to 140° C.

The internal pressure in the reactor is preferably from 0.02 bar to 100 bar, preferably from 0.05 bar to 20 bar, most preferably from 0.1 bar to 10 bar (absolute).

Most preferably, a DMC-catalysed reaction is carried out at a temperature of from 80° C. to 140° C. and a pressure of from 0.1 bar to 10 bar.

### 2,3-Epoxybutane (C)

The monomer 2,3-epoxybutane exists in the form of two isomers cis-2,3-epoxybutane (cis-2-butylene oxide) and trans-2,3-epoxybutane (trans-2-butylene oxide). According to the prior art, the two stereoisomers differ in their reactivity and lead to products having different properties.

According to the process of the invention, cis-2,3-epoxybutane and trans-2,3-epoxybutane are in a preferred embodiment simultaneously added as an isomer mixture to the reaction mixture of starter (A) and catalyst (B), the isomer mixture preferably consisting to an extent of 10% to 95% of trans-2,3-epoxybutane and 5% to 90% of cis-2,3-epoxybutane, preferably to an extent of 20% to 85% of trans-2,3-epoxybutane and 15% to 80% of cis-2,3-epoxybutane, more preferably to an extent of 40% to 80% of trans-2,3-epoxybutane and 20% to 60% of cis-2,3-epoxybutane, most preferably to an extent of 60% to 75% of trans-2,3-epoxybutane and 25% to 40% of cis-2,3-epoxybutane, and where the sum total of trans-2,3-epoxybutane and cis-2,3-epoxybutane adds up to 100%.

It is preferable when the mixture of trans-2,3-epoxybutane and cis-2,3-epoxybutane used according to the invention has a purity according to GC analysis of >90% by weight, preferably >94% by weight, more preferably >96% by weight and very particularly preferably >98% by weight.

The water content determined by the Karl Fischer method of the mixture of trans-2,3-epoxybutane and cis-2,3-epoxybutane used according to the invention is preferably <1.5% by weight, further preferably <1.0% by weight, more preferably <0.6% by weight, very particularly preferably <0.4% by weight and most preferably <0.2% by weight.

The content, in the mixture of trans-2,3-epoxybutane and cis-2,3-epoxybutane, of any C4 hydrocarbons such as butane, 1-butene, isobutane, cis-2-butene, trans-2-butene, butadiene and isobutene is according to GC analysis preferentially <3% by weight, preferably <2% by weight, more preferably <1% by weight, very particularly preferably <0.5% by weight and most preferably <0.2% by weight.

A content, in the mixture of trans-2,3-epoxybutane and cis-2,3-epoxybutane, of any other possible secondary components originating e.g. from the production process, such as alcohols or chlorinated hydrocarbons, is according to GC analysis preferentially <3% by weight, preferably <2% by weight, more preferably <1% by weight, very particularly preferably <0.5% by weight and most preferably <0.2% by weight.

The reaction is an alkoxylation reaction, i.e. a polyaddition of alkylene oxides to the at least one hydroxy-functional starter (A). The reaction according to the invention of the mixture of trans-2,3-epoxybutane and cis-2,3-epoxybutane can be carried out together with further epoxy monomers (D) from the group of the alkylene oxides or also glycidyl compounds.

### Further Epoxy Monomers (D)

It is preferable that the at least one further epoxy-functional compound is selected from the group of the alkylene oxides, more preferably from the group of the alkylene oxides having 2 to 18 carbon atoms, even more preferably from the group of the alkylene oxides having 2 to 8 carbon atoms, most preferably from the group consisting of ethylene oxide, propylene oxide, 1-butylene oxide, isobutylene oxide and/or styrene oxide; and/or that the at least one further epoxy-functional compound is selected from the group of the glycidyl compounds, more preferably from the group of the monofunctional glycidyl compounds, most preferably from the group consisting of phenyl glycidyl ether, o-cresyl glycidyl ether, tert-butylphenyl glycidyl ether, allyl glycidyl ether, butyl glycidyl ether, 2-ethylhexyl glycidyl ether, C₁₂/C₁₄ fatty alcohol glycidyl ether and/or C₁₃/C₁₅ fatty alcohol glycidyl ether.

The monomers (C) and (D) may be added individually in pure form, alternately one after the other in the desired order of metered addition, or else simultaneously in the form of a mixture. The sequence of monomer units in the resulting polyether chain is accordingly subject to a blockwise distribution or a random distribution or a gradient distribution in the end product.

The process of the invention results in the construction on the starter (A) of polyether chains having the feature of selective and reproducible preparability in terms of structure and molar mass.

The sequence of monomer units can be varied within broad limits through the sequence of addition. The use according to the invention of an isomer mixture of cis-2,3-epoxybutane and trans-2,3-epoxybutane allied with the selectivity in the alkoxylation that is characteristic of the DMC catalyst (B) surprisingly affords polyethers (E) that are less crystalline at room temperature and are instead waxy in appearance or even liquid. These have lower melting points than the solid, crystalline homopolymers of isomerically pure 2,3-epoxybutane monomers that are described in the literature. Being in the liquid state/having lower melting points makes the polyethers easier to handle, facilitating their use in downstream processes and applications quite considerably. The use according to the invention of an isomer mixture of cis-2,3-epoxybutane and trans-2,3-epoxybutane in combination with DMC catalysis also surprisingly permits more gentle reaction conditions by comparison with the pure cis or trans isomers of 2,3-epoxybutane used in the literature, as can be seen from the experiments. The low reaction temperature needed for the commencement and continuation of the reaction and also the higher rate of reaction have a very beneficial effect on the use in production processes of the described monomer unit, as demonstrated by the examples. The advantages in respect of rate of reaction and requisite reaction temperature brought by the use of the cis/trans-isomer mixture were unexpected, as were the advantages in respect of the waxy appearance or even liquid state of matter at room temperature (25° C.).

The molar masses of the polyethers formed may according to the process of the invention be varied within broad limits and controlled in a selective and reproducible manner via the molar ratio of the added monomers (C) and (D) in relation to the OH groups in the at least one starter (A).

The reaction conditions are in the DMC-catalysed alkoxylation process of the invention preferably selected such that the side reactions known from alkaline catalysis are largely suppressed. These include rearrangements of 2,3-epoxybutane and elimination of water from the terminal tertiary hydroxyl group of the growing polyether chain. NMR spectra point to the formation of compounds containing isobutenoxy radicals CH₂═CH—CH(—CHs)—O— as a structural element. The proportion of these unsaturated structures in the end product is here a measure of these side reactions and can be quantitatively determined by measurement of the iodine value or through NMR spectroscopy. This means that, especially under the preferred process conditions, less than 30%, preferably less than 25%, more preferably less than 20%, of the 2,3-epoxybutane monomers used are converted into unsaturated compounds by side reactions. This sharp decrease in the proportions of allylic side products, as demonstrated in the examples, is a further particular advantage of the present invention.

Before supplying the epoxide, i.e. before adding the first amount of the epoxy-functional compound (C) and/or (D), the reactor part-filled with the starter and DMC catalyst (B) is preferably inertized, e.g. with nitrogen. This is done e.g. by alternately evacuating and filling with nitrogen several times. It is advantageous to evacuate the reactor to below 200 mbar after the last flush with nitrogen. This means that the addition of the first amount of epoxy monomer preferably takes place into the evacuated reactor. The monomers are metered in preferably while stirring and optionally cooling in order to dissipate the heat of reaction released and to maintain the preselected reaction temperature. The starter used is the at least one hydroxy-functional compound (A), alternatively it is also possible to use as starter a polyether (E) already prepared by the process of the invention.

The reaction may be performed in a suitable solvent, for example in order to lower the viscosity. At the end of the epoxide addition, there preferably follows a period of further reaction to allow the reaction to proceed to completion. The further reaction may for example be conducted by continued reaction under the reaction conditions (i.e. with maintenance of e.g. the temperature) without addition of reactants. The DMC catalyst typically remains in the reaction mixture.

Once the reaction has taken place, unreacted epoxides and any other volatile constituents can be removed by vacuum distillation, steam- or gas-stripping, or other methods of deodorization. The end product is preferably finally filtered at <100° C. to remove any turbidity.

The use of stabilizers or antioxidants to stabilize the products during the process of the invention is preferable. Suitable for this purpose are e.g. the sterically hindered phenols known to those skilled in the art that are commercially available for example as Anox® 20, Irganox® 1010 (BASF), Irganox® 1076 (BASF) and Irganox® 1135 (BASF).

### Products as Starters

It is not always possible to achieve the desired molar mass of the end product in just a single reaction step, especially alkoxylation step. Particularly when long polyether chains are desired and/or the starter (A) has high OH-group functionality, it is necessary to add large amounts of epoxy monomers.

This is sometimes not permitted by the reactor geometry. The polyethers (E) prepared according to the invention bear terminal OH groups and are accordingly themselves suitable as the starter for the construction of subsequent high-molecular-weight products. They are thus for the purposes of the invention both potential precursors and starter compounds for the synthesis of polyethers of higher molar mass. The reaction of 2,3-epoxybutane (C) and optional further epoxy-functional compounds (D) can thus take place in a plurality of substeps.

### Reactors

For the process according to the invention, it is in principle possible to use any suitable reactor types that allow control over the reaction and any exothermicity present. The reaction regime may be executed continuously, semicontinuously or else batchwise, in a manner known in process technology, and can be flexibly tailored to the production equipment available. Besides conventional stirred-tank reactors, it is also possible to use jet-loop reactors with a gas phase and internal heat exchanger tubes as described in WO 01/062826. It is also possible to use loop reactors having no gas phase.

### Optional Step b)

In an optional further step b), the at least one polyether (E) based on 2,3-epoxybutane (C) is reacted with at least one endcapping reagent (F) to afford at least one polyether (G) containing endcapped polyether residues. In this step, the terminal hydroxy groups of the polyethers (E) are reacted further to form ester, ether, urethane and/or carbonate groups. The endcapping of polyethers is known to those skilled in the art, for example esterification with carboxylic acids or carboxylic anhydrides, in particular acetylation using acetic anhydride, etherification with halogenated hydrocarbons, in particular methylation with methyl chloride according to the principle of the Williamson ether synthesis, urethanization through reaction of the OH groups with isocyanates, in particular with monoisocyanates such as stearyl isocyanate, and carbonation through reaction with dimethyl carbonate and diethyl carbonate.

### Polyethers Based on 2,3-epoxybutanes

The present invention further provides polyethers (E) of the formula (2) based on 2,3-epoxybutane (C), as preparable by the process of the invention.

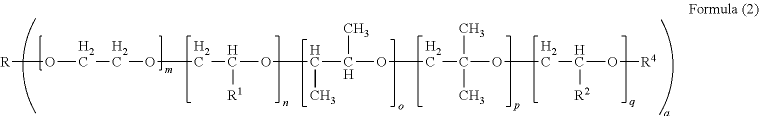

where
R is a saturated or unsaturated, linear or branched radical having 1 to 500 carbon atoms, preferably having 2 to 250 carbon atoms, more preferably having 3 to 100 carbon atoms, in which the carbon chain may be interrupted by heteroatoms such as oxygen, nitrogen or silicon,
a is an integer from 1 to 8, preferably from 1 to 6, more preferably from 1 to 4 and very particularly a preferably from 1 to 3,
R¹ is in each case independently a monovalent hydrocarbon radical having 1 to 16 carbon atoms; preferably in each case independently an alkyl radical having 1 to 16 carbon atoms or a phenyl radical;
   most preferably in each case independently a methyl radical, an ethyl radical or a phenyl radical;
R² is a radical of the formula —CH₂—O—R³,
R³ is in each case independently a monovalent hydrocarbon radical having 3 to 18 carbon atoms; preferably in each case independently an allyl radical, a butyl radical, an alkyl radical having 8 to 15 carbon atoms or a phenyl radical that may be substituted by monovalent radicals selected from hydrocarbon radicals having 1 to 4 carbon atoms; most preferably a tert-butylphenyl radical or an o-cresyl radical;
R⁴ is in each case independently a monovalent organic radical having 1 to 18 carbon atoms or hydrogen, preferably hydrogen,
m, n, p and q are each independently 0 to 300, preferably 0 to 200, most preferably 0 to 100,
o is a number from 1 to 300, preferably 1 to 200, more preferably 2 to 150 and very particularly preferably 3 to 100,
   with the proviso that the sum total of m, n, o, p and q is greater than 1, preferably greater than 5, most preferably greater than 10.

The radicals R¹, R², R³ and R⁴ may each independently be linear or branched, saturated or unsaturated, aliphatic or aromatic, and substituted or unsubstituted.

The general notation

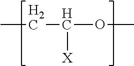

where X=R¹ or R², or X=CH₃, represents in formula (2) either a unit of the formula

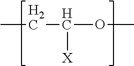

or a unit of the formula

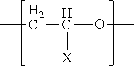

but preferably a unit of the formula

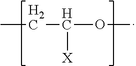

The general notation

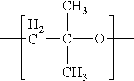

represents in formula (2) either a unit of the formula

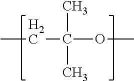

or a unit of the formula

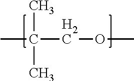

but preferably a unit of the formula

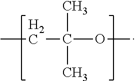

The repeat units resulting from ring opening of cis-2,3-epoxybutane and trans-2,3-epoxybutane are present o times in the polyether chain of the formula (2). The radical R corresponds to the radical in starter compound (A) defined in formula (1).

For example, R is a radical derived from starter compounds of the formula (1), such as allyl alcohol, allyloxyethanol, allyloxypropanol, methallyl alcohol, butanol, 5-hexen-1-ol, hexanol, octanol, 3,5,5-trimethylhexanol, isononanol, decanol, dodecanol, tetradecanol, hexadecanol, stearyl alcohol, 2-ethylhexanol, cyclohexanol, benzyl alcohol, trimethylolpropane diallyl ether, trimethylolpropane monoallyl ether, glycerol diallyl ether, glycerol monoallyl ether, diethylene glycol monomethyl ether, diethylene glycol monobutyl ether, dipropylene glycol monomethyl ether, dipropylene glycol monobutyl ether, ethylene glycol, propylene glycol, di-, tri- and polyethylene glycol, 1,2-propylene glycol, di- and polypropylene glycol, butane-1,4-diol, hexane-1,6-diol, trimethylolpropane, glycerol, polyglycerol, pentaerythritol, sorbitol, or else other hydroxyl-bearing compounds based on natural products. In addition to compounds having aliphatic and cycloaliphatic OH groups, any desired compounds having phenolic OH functions are suitable. These include by way of example phenol, alkyl- and arylphenols, bisphenol A and/or novolaks.

Preferably, R is an organic radical derived from allyl alcohol, allyloxyethanol, allyloxypropanol, methallyl alcohol, butanol, dipropylene glycol, glycerol and/or polyetherols having 1-8 hydroxyl groups and molar masses of 50 to 5000 g/mol that had in turn been prepared by a prior alkoxylation.

It is further preferable that the radical R⁴ is in each case independently selected from the group consisting of monovalent hydrocarbon radicals having 1 to 18 carbon atoms, acyl radicals —C(═O)R⁵, urethane radicals —C(═O)NH—R⁶, carbonate radicals —C(═O)O—R⁷ and/or hydrogen; more preferably, R⁴ is in each case independently selected from the group consisting of alkyl radicals having 1 to 18 carbon atoms, alkylene radicals having 1 to 18 carbon atoms, acyl radicals —C(═O)R⁵, urethane radicals —C(═O)NH—R⁶, carbonate radicals —C(═O)O—R⁷ and/or hydrogen; most preferably, R⁴ is hydrogen, where the term “hydrogen” denotes a hydrogen radical.

R⁵ is in each case independently an alkyl or alkenyl radical having 1 to 18 carbon atoms, preferably having 1 to 10 carbon atoms, most preferably a methyl radical.

R⁶ is in each case independently an alkyl or aryl radical having 1 to 18 carbon atoms, preferably having 6 to 18 carbon atoms.

R⁷ is in each case independently an alkyl radical having 1 to 18 carbon atoms, preferably having 1 or 2 carbon atoms.

The proportion of the repeat units shown in formula (2) resulting from cis-2,3-epoxybutane and trans-2,3-epoxybutane and having the index o is, based on the sum total of all repeat units shown in formula (2), preferably from >0% to 100%, more preferably from 10% to 100%, even more preferably from 20% to 100%, most preferably from 25% to 80%, where the proportion is calculated as

[o/(m+n+o+p+q)]*100%.

The repeat units with the indices m, n, o, p and q are distributed in a freely variable, random manner over the polyether chain. All stated indices should therefore be regarded as averages.

The number-average molar mass Mₙ, weight-average molar mass M_{w} and polydispersity of the polyether (E) are freely variable.

It is preferable that the number-average molar mass Mₙ of the polyether (E) is from 200 g/mol to 30 000 g/mol, preferably from 300 g/mol to 10 000 g/mol, most preferably from 400 g/mol to 5000 g/mol.

The polydispersity (M_{w}/Mₙ) of the polyethers (E) is variable within wide ranges and is preferably from 1.05 to 5, more preferably from 1.1 to 4 and particularly preferably from 1.15 to 3.

The polyethers (E) of the invention are preferably characterized in that they contain according to NMR spectroscopic analysis, per mole of 2,3-epoxybutane (C) used according to the invention, preferably less than 0.3 moles of C═C double bonds, more preferably less than 0.25 moles of C═C double bonds, particularly preferably less than 0.2 moles of C═C double bonds. Not included here are C═C double bonds introduced into the polyether (E) by unsaturated starters (A) such as allyl alcohol or other unsaturated epoxy monomers (D) such as allyl glycidyl ether.

The unsaturated compounds formed through unavoidable side reactions of 2,3-epoxybutane cannot be removed from the polyether (E) end product and are thus an inseparable constituent of the polyethers (E) of the invention.

The examples that follow describe the present invention by way of example, without any intention that the invention, the scope of application of which is apparent from the entirety of the description and the claims, be restricted to the embodiments specified in the examples.

### EXAMPLES

### General Methods

### Gel Permeation Chromatography (GPC)

GPC measurements for determination of the polydispersity (M_{w}/Mₙ), weight-average molar mass (M_{w}) and number-average molar mass (Mₙ) of the polyethers (E) were carried out under the following measurement conditions: SDV 1000/10 000 Å column combination (length 65 cm), temperature 30° C. THF as mobile phase, flow rate 1 ml/min, sample concentration 10 g/l, RI detector, evaluation against polypropylene glycol standard.

### Determination of the Acid Value

The acid value was determined by a titration method based on DIN EN ISO 2114.

### Determination of the Hydroxyl Value (OH Value)

Hydroxyl values were determined by method DGF C-V 17 a (53) of the Deutsche Gesellschaft für Fettwissenschaft [German Society for Fat Science]. This involved acetylating the samples with acetic anhydride in the presence of pyridine and determining the volume of acetic anhydride consumed by titration with 0.5 N potassium hydroxide solution in ethanol against phenolphthalein.

### Determination of Purity and of the Cis/trans-isomer Ratio (GC)

For determination of secondary components in the 2,3-epoxybutane by GC, a portion of the sample is analyzed directly by GC/TCD. This is performed in a gas chromatograph equipped with a split/splitless injector, a capillary column and a thermal conductivity detector, under the following conditions:

Injector: 290° C., split 1:50

Injection volume: 1 μL

Column: 10 m*0.32 mm; 5 μm CP-PoraBond Q

Carrier gas: Helium, constant flow, 2 ml/min

Temperature program: 50° C.-300° C. at 15° C./min, then conditioning for 10 minutes at 300° C.

Detector: TCD at 310° C.
Make-up gas 2 ml/min
Reference gas 20 ml/min.

Impurities such as water, alkanes and dichloromethane are evaluated on the basis of their proportions in area %.

For determination of the cis-trans-isomer ratio of the 2,3-epoxybutane by GC, a portion of the sample is dissolved in ethylbenzene and analysed directly by GC/FID.

This is performed in a gas chromatograph equipped with a split/splitless injector, a capillary column and a flame ionization detector, under the following conditions:
Injector: 290° C., split 1:40
   Injection volume: 1 μL
Column: 50 m*0.32 mm HP5 1.05 μm
Carrier gas: Hydrogen, constant flow, 2 ml/min
Temperature program: 2 min at 50° C. -200° C. at 5° C./min, then
   200″C-300° C. at 25° C./min, then
   conditioning for 5 minutes at 300° C.
Detector: FID at 310° C.
   Hydrogen 30 ml/min
   Air 400 ml/min
   Make-up gas 12 ml/min.

The cis-trans-isomer ratio is determined on the basis of the proportions in area %.

### Determination of Turbidity Values

Turbidity values were determined using a Lange 2100AN IS turbidimeter, ISO, 230 V, from Hach, an 870 nm LED light source and 11 mm round cuvettes.

### Determination of Melting Points and Enthalpies (DSC)

Melting points and enthalpies were determined using the Discovery DSC from TA Instruments. The measurement was performed in an aluminum T Zero crucible and with a sample weight of 15 mg under nitrogen, at a temperature from 0-150° C. and a ramp rate of 5.0° C. per minute.

### Determination of the Proportion of Unsaturated Compounds Based on the Amount of 2,3-epoxybutane Used

The proportion of unsaturated compounds based on the amount of 2,3-epoxybutane used is e.g. caused by side reactions of 2,3-epoxybutane and/or elimination of water from terminal tertiary OH groups. The determination was performed by ¹³C-NMR spectroscopy. A Bruker Advance 400 NMR spectrometer was used. The samples were for this purpose dissolved in deuterochloroform. The content of unsaturated compounds is defined as the proportion of unsaturated compounds based on the amount of 2,3-epoxybutane used*100%. The content is determined by determining by ¹³C NMR the number of moles of double bonds per 1 mole of starter and dividing this by the number of moles of 2,3-epoxybutane per 1 mole of starter specified by the formulation and multiplying by 100%.

### Synthesis Examples

### Example 1: Alkoxylation with Potassium Methoxide as Catalyst (Noninventive)

For preparation of a polyether (E) of the formula (2) based on cis/trans-2,3-epoxybutane by alkaline catalysis, a 3-litre autoclave was charged under nitrogen with 71.3 g of a butanol-started polyether having a molecular weight of 350 g/mol and 2.0 g of potassium methoxide. This was then heated to 115° C. while stirring and the reactor evacuated down to an internal pressure of 30 mbar to remove any volatile constituents by distillation. 79.2 g of cis/trans-2,3-epoxybutane were added at 140° C. with stirring and cooling. After a discernible fall in pressure, a further 135.5 g of cis/trans-2,3-epoxybutane were metered in continuously at 140° C. with stirring and max. 3.0 bar reactor internal pressure (absolute) over a period of 4.5 hours. The mixture was allowed to react at 140° C. for a further 4 hours and was then degassed. Volatiles were distilled off under reduced pressure. The mass of the distillate was 78.0 g and contained no free 2,3-epoxybutane, but instead consisted almost exclusively of short-chain, unsaturated constituents formed by rearrangement. The proportion of unsaturated compounds based on the amount of 2,3-epoxybutane used, which is determined from the ¹³C NMR of the product, accordingly does not reflect the total amount of the unsaturated compounds fraction. The product was cooled to below 80° C., neutralized with lactic acid and 500 ppm of Irganox® 1135 were added. 168.3 g of the liquid polyether, which was brown at room temperature, were obtained.

M_{w}=511 g/mol; Mₙ=347 g/mol; M_{w}/Mₙ=1.47

OH value=170.8 mg KOH/g Acid value=0.1 mg KOH/g.

Proportion of unsaturated compounds based on the amount of 2,3-epoxybutane used: 13.4%.

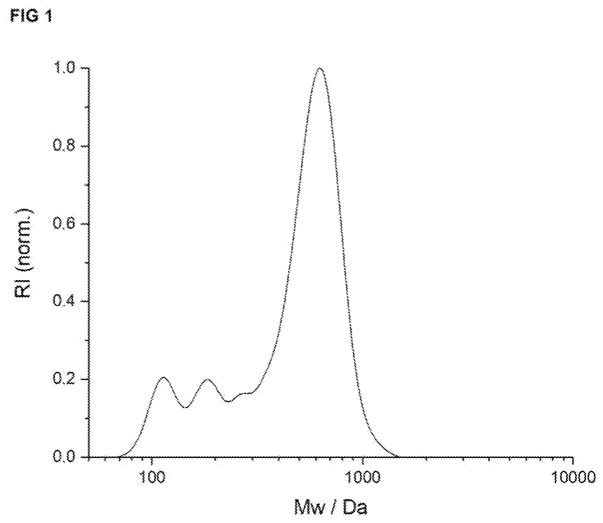

The GPC curve shows a multimodal distribution and high proportions of low-molecular-weight unsaturated compounds, cf. figure FIG. 1.

Composition of the 2,3-epoxybutane used:
cis/trans ratio: 50/50 w/w (GC/FID)
Purity: >98%
Water content: <500 ppm.

### Example 2: Alkoxylation with Zn/Co Catalyst (DMC) and a Cis/Trans-2,3-epoxybutane Mixture (Inventive)

For preparation of a polyether (E) of the formula (2) based on 2,3-epoxybutane by DMC catalysis, a 3-litre autoclave was charged under nitrogen with 71.9 g of a butanol-started polyether having a molecular weight of 350 g/mol and 0.041 g of DMC catalyst. This was then heated to 115° C. while stirring and the reactor evacuated down to an internal pressure of 30 mbar to remove any volatile constituents by distillation. 30.2 g of 2,3-epoxybutane were added at 140° C. with stirring and cooling. After a discernible fall in pressure, a further 184.6 g of 2,3-epoxybutane were metered in continuously at 140° C. with stirring and cooling and max. 3.0 bar reactor internal pressure (absolute) over a period of 20 minutes. The mixture was allowed to react at 140° C. for a further 20 minutes and was then degassed. Volatiles such as residual 2,3-epoxybutane were distilled off under reduced pressure. The product was cooled to below 80° C. and 500 ppm of Irganox® 1135 added. 271.0 g of the liquid, colourless polyether, which was slightly turbid at room temperature, were obtained.

M_{w}=1250 g/mol; Mₙ=954 g/mol; M_{w}/Mₙ=1.31

OH value=59.9 mg KOH/g Acid value=0.1 mg KOH/g.

Proportion of unsaturated compounds based on the amount of 2,3-epoxybutane used: 1.9%.

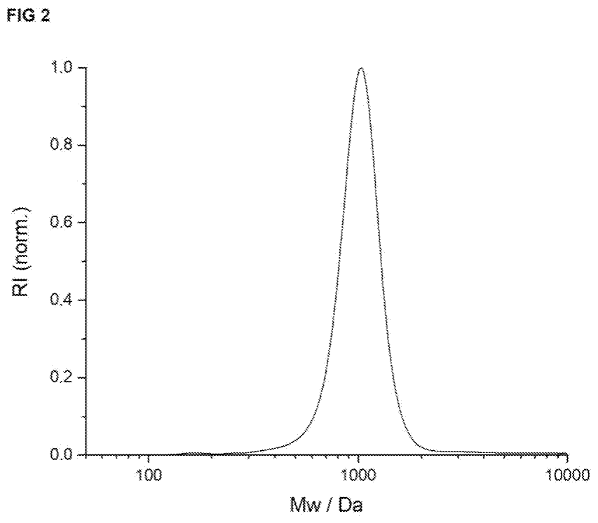

The GPC curve of the product shows a unimodal distribution, cf. figure FIG. 2.

Composition of the 2,3-epoxybutane used:
cis/trans ratio: 50/50 w/w (GC/FID)
Purity: >98%
Water content: <500 ppm.

### Example 3: Alkoxylation with Zn/Co Catalyst (DMC) and Pure Trans-2,3-epoxybutane

For preparation of a polyether (E) of the formula (2) based on trans-2,3-epoxybutane, a 3-litre autoclave was charged under nitrogen with 79.1 g of decanol and 0.18 g of DMC catalyst. This was then heated to 130° C. while stirring and the reactor evacuated down to an internal pressure of 30 mbar to remove any volatile constituents by distillation. 110.0 g of trans-2,3-epoxybutane were added at 140° C. with stirring and cooling. After a discernible fall in pressure, a further 411.5 g of trans-2,3-epoxybutane were metered in continuously at 140° C. with stirring and cooling and max. 3.0 bar reactor internal pressure (absolute) over a period of 4 hours. The mixture was allowed to react at 130° C. for a further 3 hours and was then degassed. Volatiles such as residual trans-2,3-epoxybutane were distilled off under reduced pressure. The product was cooled to below 80° C. and 0.3 g of Irganox® 1135 added. 564.1 g of the colourless polyether, which was solid at room temperature, were obtained.

M_{w}=926 g/mol: Mₙ=849 g/mol; M_{w}/Mₙ=1.09

OH value=64.5 mg KOH/g Acid value=0.1 mg KOH/g.

Proportion of unsaturated compounds based on the amount of trans-2,3-epoxybutane used: 1.5%. The product is crystalline. DSC shows a melting peak at 48.4° C. The enthalpy of fusion is 19.29 J/g.

Composition of the 2.3-epoxybutane used:
cis/trans ratio: 0/100 w/w
Purity: >98%
Water content: <500 ppm.

### Example 4: Alkoxylation with Zn/Co Catalyst (DMC) and a Cis/trans-2,3-epoxybutane Mixture

For preparation of a polyether (E) of the formula (2) based on 2,3-epoxybutane, a 3-litre autoclave was charged under nitrogen with 48.5 g of decanol and 0.18 g of DMC catalyst. This was then heated to 130° C. while stirring and the reactor evacuated down to an internal pressure of 30 mbar to remove any volatile constituents by distillation. 50.3 g of cis/trans-2,3-epoxybutane were added at 130° C. with stirring and cooling. After a discernible fall in pressure, a further 276.4 g of cis/trans-2.3-epoxybutane were metered in continuously at 130° C. with stirring and cooling and max. 3.0 bar reactor internal pressure (absolute) over a period of one hour. The mixture was allowed to react at 130° C. for a further 30 minutes and was then degassed. Volatiles such as residual cis/trans-2,3-epoxybutane were distilled off under reduced pressure. The product was cooled to below 80° C. and 0.18 g of Inganox® 1135 added. 332.1 g of the colourless polyether, which was pasty at room temperature, were obtained.

M_{w}=964 g/mol: Mₐ=897 g/mol; M_{w}/Mₙ=1.07

OH value=59.0 mg KOH/g Acid value=0.1 mg KOH/g.

Proportion of unsaturated compounds based on the amount of cis/trans-2,3-epoxybutane used: 1.6%.

The product is only slightly crystalline. DSC shows a small melting peak at 43.4° C. The enthalpy of fusion is 3.05 J/g.

Composition of the cis/trans-2,3-epoxybutane used:
cis/trans ratio: 12/88 w/w (GC/FID)
Purity: >98%
Water content: <500 ppm.

### Example 5: Alkoxylation with Zn/Co Catalyst (DMC) and a Cis/trans-2,3-epoxybutane Mixture

For preparation of a polyether (E) of the formula (2) based on cis/trans-2,3-epoxybutane, a 3-litre autoclave was charged under nitrogen with 48.8 g of decanol and 0.18 g of DMC catalyst. This was then heated to 130° C. while stirring and the reactor evacuated down to an internal pressure of 30 mbar to remove any volatile constituents by distillation. 34.8 g of cis/trans-2,3-epoxybutane were added with stirring and cooling. After a discernible fall in pressure, a further 291.2 g of cis/trans-2,3-epoxybutane were metered in continuously at 130° C. with stirring and cooling and max. 3.0 bar reactor internal pressure (absolute) over a period of half an hour. The mixture was allowed to react at 130° C. for a further 30 minutes and was then degassed. Volatiles such as residual cis/trans-2,3-epoxybutane were distilled off under reduced pressure. The product was cooled to below 80° C. and 0.18 g of Irganox® 1135 added. 316.1 g of the colourless polyether, which was slightly pasty at room temperature, were obtained.

M_{w}=985 g/mol; Mₙ=912 g/mol; M_{w}/Mₙ=1.08

OH value=60.7 mg KOH/g Acid value=0.1 mg KOH/g.

Proportion of unsaturated compounds based on the amount of cis/trans-2,3-epoxybutane used: 1.6%.

Composition of the 2,3-epoxybutane used:
cis/trans ratio: 50/50 w/w (GC/FID)
Purity: >98%
Water content: <500 ppm.

### Example 6: Alkoxylation with Zn/Co Catalyst (DMC) and Pure Trans-2,3-epoxybutane

For preparation of a polyether (E) of the formula (2) based on trans-2,3-epoxybutane, a 3-litre autoclave was charged under nitrogen with 73.3 g of a butanol-started polyether having a molecular weight of 385 g/mol and 0.09 g of DMC catalyst. This was then heated to 115° C. while stirring and the reactor evacuated down to an internal pressure of 30 mbar to remove any volatile constituents by distillation. 33 g of propylene oxide was metered in at 130° C. with stirring and cooling. After a discernible fall in pressure, the mixture was heated to 140° C. and a further 11.3 g of propylene oxide followed by 203.7 g of trans-2,3-epoxybutane were metered in continuously at 140° C. with cooling and max. 3.0 bar reactor internal pressure (absolute) over a period of 4 hours. The mixture was allowed to react at 140° C. for a further 1.5 hours and was then degassed. Volatiles such as residual propylene oxide and trans-2,3-epoxybutane were distilled off under reduced pressure. The product was cooled to below 80° C. and 0.15 g of Irganox® 1135 added. 275.7 g of the colourless polyether, which was solid at room temperature, were obtained.

M_{w}=1358 g/mol; Mₙ=1029 g/mol; M_{w}/Mₙ=1.32

OH value =51.5 mg KOH/g Acid value=0.1 mg KOH/g.

Proportion of unsaturated compounds based on the amount of trans-2,3-epoxybutane used: 1.8%.

The product is only slightly crystalline. DSC shows a small melting peak at 48.1° C. The enthalpy of fusion is 7.12 J/g.

Composition of the 2,3-epoxybutane used:
cis/trans ratio: 0/100 w/w
Purity: >98%
Water content: <500 ppm.

### Example 7: Alkoxylation with Zn/Co Catalyst (DMC) and a Cis/trans-2,3-epoxybutane Mixture

For preparation of a polyether (E) of the formula (2) based on cis/trans-2,3-epoxybutane, a 3-litre autoclave was charged under nitrogen with 73.0 g of a butanol-started polyether having a molecular weight of 385 g/mol and 0.09 g of DMC catalyst. This was then heated to 130° C. while stirring and the reactor evacuated down to an internal pressure of 30 mbar to remove any volatile constituents by distillation. 32.8 g of propylene oxide were metered in with stirring and cooling. After a discernible fall in pressure, a further 11.0 g of propylene oxide followed by 203.4 g of cis/trans-2,3-epoxybutane were metered in continuously at 130° C. with stirring and cooling and max. 3.0 bar reactor internal pressure (absolute) over a period of 30 minutes. The mixture was allowed to react at 130° C. for a further hour and was then degassed. Volatiles such as residual propylene oxide and cis/trans-2,3-epoxybutane were distilled off under reduced pressure. The product was cooled to below 80° C. and 0.16 g of Irganox 1135 added. 291.7 g of the colourless polyether, which was pasty at room temperature, were obtained.

M_{w}=1266 g/mol; Mₙ=1164 g/mol; M_{w}/Mₙ=1.09

OH value=43.5 mg KOH/g Acid value=0.1 mg KOH/g.

Proportion of unsaturated compounds based on the amount of 2,3-epoxybutane used: 2.5%. The product is only very slightly crystalline. DSC shows a small melting peak at 43.8° C. The enthalpy of fusion is only 1.65 J/g.

Composition of the 2,3-epoxybutane used:
cis/trans ratio: 12/88 w/w (GC/FID)
Purity: >98%
Water content: <500 ppm.

### Example 8: Alkoxylation with Zn/Co Catalyst (DMC) and a Cis/trans-2,3-epoxybutane Mixture

For preparation of a polyether (E) of the formula (2) based on cis/trans-2,3-epoxybutane, a 3-litre autoclave was charged under nitrogen with 73.2 g of a butanol-started polyether having a molecular weight of 385 g/mol and 0.09 g of DMC catalyst. This was then heated to 130° C. while stirring and the reactor evacuated down to an internal pressure of 30 mbar to remove any volatile constituents by distillation. 20.4 g of propylene oxide were metered in with stirring and cooling. After a discernible fall in pressure, a further 11.3 g of propylene oxide followed by 216.1 g of 2,3-epoxybutane were metered in continuously at 130° C. with stirring and cooling and max. 3.0 bar reactor internal pressure (absolute) over a period of 20 minutes. The mixture was allowed to react at 130° C. for a further 30 minutes and was then degassed. Volatiles such as residual propylene oxide and cis/trans-2,3-epoxybutane were distilled off under reduced pressure. The product was cooled to below 80° C. and 0.16 g of Irganox® 1135 added. 331.2 g of the colourless polyether, which was slightly pasty at room temperature, were obtained.

M_{w}=1362 g/mol; Mₙ=1207 g/mol; M_{w}/Mₙ=1.13

OH value=48.2 mg KOH/g Acid value=0.1 mg KOH/g.

Proportion of unsaturated compounds based on the amount of cis/trans-2,3-epoxybutane used: 2.2%.

Composition of the 2,3-epoxybutane used:
cis/trans ratio: 50/50 w/w (GC/FID)
Purity: >98%
Water content: <500 ppm.

### Example 9: Alkoxylation with Zn/Co Catalyst (DMC) and a trans-2,3-epoxybutane/propylene Oxide Mixture

For preparation of a polyether (E) of the formula (2) based on trans-2,3-epoxybutane, a 3-litre autoclave was charged under nitrogen with 73.3 g of a butanol-started polyether having a molecular weight of 385 g/mol and 0.16 g of DMC catalyst. This was then heated to 130° C. while stirring and the reactor evacuated down to an internal pressure of 30 mbar to remove any volatile constituents by distillation. 30.1 g of propylene oxide were metered in with stirring and cooling. After a discernible fall in pressure, a further 14.3 g of propylene oxide followed by a mixture of 203.4 g of trans-2,3-epoxybutane and 202.8 g of propylene oxide were metered in continuously at 130° C. with stirring and cooling and max. 3.0 bar reactor internal pressure (absolute) over a period of 2 hours. The mixture was allowed to react at 130″° C. for a further 2 hours and was then degassed. Volatiles such as residual propylene oxide and trans-2,3-epoxybutane were distilled off under reduced pressure. The product was cooled to below 80° C. and 0.25 g of Irganox® 1135 added. 479.8 g of the slightly turbid polyether, which was liquid at room temperature, were obtained.

M_{w}=2033 g/mol; Mₙ=1791 g/mol; M_{w}/Mₙ=1.14

OH value=30.5 mg KOH/g Acid value=0.1 mg KOH/g.

Proportion of unsaturated compounds based on the amount of 2,3-epoxybutane used: 3.7%.

Turbidity value: 54.5 NTU

Composition of the 2,3-epoxybutane used:
cis/trans ratio: 0/100 w/w (GC/FID)
Purity: >98%
Water content: <500 ppm.

### Example 10: Alkoxylation with Zn/Co Catalyst (DMC) and a cis/trans-2,3-epoxybutane/propylene Oxide Mixture

For preparation of a polyether (E) of the formula (2) based on cis/trans-2,3-epoxybutane, a 3-litre autoclave was charged under nitrogen with 73.3 g of a butanol-started polyether having a molecular weight of 385 g/mol and 0.16 g of DMC catalyst. This was then heated to 130° C. while stirring and the reactor evacuated down to an internal pressure of 30 mbar to remove any volatile constituents by distillation. 32.5 g of propylene oxide were metered in with stirring and cooling. After a discernible fall in pressure, a further 11.2 g of propylene oxide followed by a mixture of 203.4 g of cis/trans-2,3-epoxybutane and 203.1 g of propylene oxide were metered in continuously at 130° C. with stirring and cooling and max. 3.0 bar reactor internal pressure (absolute) over a period of 1.5 hours. The mixture was allowed to react at 130° C. for a further hour and was then degassed. Volatiles such as residual propylene oxide and cis/trans-2,3-epoxybutane were distilled off under reduced pressure. The product was cooled to below 80° C. and 0.25 g of Irganox® 1135 added. 486.2 g of the almost clear polyether, which was liquid at room temperature, were obtained.

M_{w}=1942 g/mol; Mₙ=1685 g/mol; M_{w}/Mₙ=1.17

OH value=29.7 mg KOH/g Acid value=0.1 mg KOH/g.

Proportion of unsaturated compounds based on the amount of 2,3-epoxybutane used: 2.3%.

Turbidity value: 7.1 NTU

The much lower turbidity value compared to example 9 demonstrates the lower crystallinity of the product obtained through use of a cis- and trans-2.3-epoxybutane isomer mixture.

Composition of the 2,3-epoxybutane used:
cis/trans ratio: 12/88 w/w (GC/FID)
Purity: >98%
Water content: <500 ppm.

### Example 11: Alkoxylation with Zn/Co Catalyst (DMC) and a cis/trans-2,3-epoxybutane Mixture.

Multistep process for preparing a trifunctional polyether

### Step a)

For preparation of a polyether (E) of the formula (2) based on cis/trans-2,3-epoxybutane with glycerol as starter, in a first step a) a 3-litre autoclave was charged under nitrogen with 460.5 g of glycerol and 17.5 g of potassium methoxide. This was then heated to 115° C. while stirring and the reactor evacuated down to an internal pressure of 30 mbar to remove any volatile constituents by distillation. 50.0 g of propylene oxide were added with stirring and cooling. After a discernible fall in pressure, a further 2690.5 g of propylene oxide were metered in continuously at 115° C. with stirring and cooling and max. 3.0 bar reactor internal pressure (absolute) over a period of four hours. The mixture was allowed to react at 115° C. for a further hour and was then degassed. Volatiles such as residual propylene oxide were distilled off under reduced pressure. The product was cooled to 95° C., neutralized with 30% H3PO4 and 1.6 g of Anox® 20 were added. Water was removed by distillation under reduced pressure and precipitated salts were filtered off. 3097.5 g of the colourless polyether, which was liquid at room temperature, were obtained.

OH value=244.0 mg KOH/g Acid value=0.1 mg KOH/g.

### Step b)

For preparation of a polyether (E) of the formula (2) based on cis/trans-2,3-epoxybutane with glycerol as starter, in a second step b) a 3-litre autoclave was charged under nitrogen with 100.0 g of the polyether prepared in step a) and 0.13 g of DMC. This was then heated to 130° C. while stirring and the reactor evacuated down to an internal pressure of 30 mbar to remove any volatile constituents by distillation. 40.3 g of cis/trans-2,3-epoxybutane were added with stirring and cooling. After a discernible fall in pressure, a further 549.5 g of 2,3-epoxybutane were metered in continuously at 130° C. with stirring and cooling and max. 3.0 bar reactor internal pressure (absolute) over a period of 5 hours. The mixture was allowed to react at 130° C. for a further hour and was then degassed. Volatiles such as residual cis/trans-2,3-epoxybutane were distilled off under reduced pressure. The product was cooled to below 80° C. and 1.6 g of Anox® 20 added. 647.9 g of the polyether, which was liquid and colourless at room temperature, were obtained.

OH value=58.8 mg KOH/g Acid value=0.1 mg KOH/g.

### Step c)

For preparation of a polyether (E) of the formula (2) based on cis/trans-2,3-epoxybutane with glycerol as starter, in a third step c) a 3-litre autoclave was charged under nitrogen with 643.2 g of the polyether prepared in step b) and 1.65 g of potassium methoxide. This was then heated to 115° C. while stirring and the reactor evacuated down to an internal pressure of 30 mbar to remove any volatile constituents by distillation. 79.0 g of ethylene oxide were metered in continuously at 115° C. with stirring and cooling and max. 3.0 bar reactor internal pressure (absolute) over a period of 2.5 hours. The mixture was allowed to react at 115° C. for a further hour and was then degassed.

Volatiles such as residual ethylene oxide were distilled off under reduced pressure. The product was cooled to 95″° C., neutralized with 30% HaPO₄ and 0.36 g of Anox® 20 was added. Water was removed by distillation under reduced pressure and precipitated salts were filtered off. 684.2 g of the polyether, which was liquid and colourless at room temperature, were obtained.

M_{w}=2448 g/mol; Mₙ=1847 g/mol; M_{w}/Mₙ=1.33

OH value=51.0 mg KOH/g Acid value=0.1 mg KOH/g.

Composition of the 2,3-epoxybutane used:
cis/trans ratio: 33/67 w/w (GC/FID)
Purity: >98%
Water content: <500 ppm.

### Example 12: Alkoxylation with Zn/Co Catalyst (DMC) and a Cis/trans-2,3-epoxybutane Mixture

### Preparation of a Bifunctional Polyether

For preparation of a bifunctional polyether (E) of the formula (2) based on cis/trans-2,3-epoxybutane, a 3-litre autoclave was charged under nitrogen with 114.5 g of a polypropylene glycol having a molecular weight of 477 g/mol and 0.19 g of DMC catalyst. This was heated to 130° C. while stirring and the reactor evacuated down to an internal pressure of 30 mbar to remove any volatile constituents by distillation. 48.0 g of cis/trans-2,3-epoxybutane were added with stirring and cooling. After a discernible fall in pressure, a further 315.4 g of cis/trans-2,3-epoxybutane followed by 139.2 g of propylene oxide were metered in continuously at 130° C. with stirring and cooling and max. 3.0 bar reactor internal pressure (absolute) over a period of three hours. The mixture was allowed to react at 130° C. for a further hour and was then degassed. Volatiles such as residual cis/trans-2,3-epoxybutane and propylene oxide were distilled off under reduced pressure. The product was cooled to 95° C. and 0.3 g of Irganox® 1135 added. 583.9 g of the colourless polyether, which was liquid at room temperature, were obtained.

M_{w}=1805 g/mol; Mₙ=1507 g/mol; M_{w}/Mₙ=1.20

OH value=56.5 mg KOH/g Acid value=0.1 mg KOH/g.

Composition of the 2,3-epoxybutane used:
cis/trans ratio: 33/67 w/w (GC/FID)
Purity: >98%
Water content: <500 ppm.

### Example 13: Alkoxylation with Zn/Co Catalyst (DMC) and a Cis/trans-2,3-epoxybutane Mixture

Preparation of an allyl-functional polyether.

For preparation of an allyl-functional polyether (E) of the formula (2) based on cis/trans-2,3-epoxybutane, a 3-litre autoclave was charged under nitrogen with 50.2 g of allyl alcohol and 0.28 g of DMC catalyst. While stirring, the reactor was evaluated down to an internal pressure of 100 mbar and the contents then heated to 130° C. 50.4 g of propylene oxide were added with stirring and cooling. After a discernible fall in pressure, a further 150.0 g of propylene oxide followed by 917.8 g of cis/trans-2,3-epoxybutane were metered in continuously at 130° C. with stirring and cooling and max. 3.0 bar reactor internal pressure (absolute) over a period of three hours. The mixture was allowed to react at 130° C. for a further hour and was then degassed. Volatiles such as residual cis/trans-2,3-epoxybutane and propylene oxide were distilled off under reduced pressure. The product was cooled to 95° C. and 0.6 g of Irganox® 1135 added. 1097.4 g of the colourless polyether, which was slightly pasty at room temperature, were obtained.

M_{w}=1172 g/mol; Mₙ=1002 g/mol; M_{w}/Mₐ=1.17

OH value=54.4 mg KOH/g Acid value=0.1 mg KOH/g.

Proportion of unsaturated compounds based on the amount of cis/trans-2,3-epoxybutane used: 2.2%.

Composition of the 2,3-epoxybutane used:
cis/trans ratio: 33/67 w/w (GC/FID)
Purity: >98%
Water content: <500 ppm.

1. A process for preparing polyethers based on cis-2,3-epoxybutane and trans-2,3-epoxy butane, the process comprising:
a) reacting at least one starter compound (A) in the presence of a double metal cyanide catalyst (B), with 2,3-epoxybutane (C) and optionally further epoxy monomers (D), to afford at least one polyether (E): and
optionally
b) reacting the at least one polyether (E) with at least one endcapping reagent (F), to afford at least one endcapped polyether (G).

2. The process according to claim 1, wherein the at least one starter compound (A) used is a compound of the formula (1),
R(—OH)ₐ (1)
wherein
R is a saturated or unsaturated, linear or branched radical having 1 to 500 carbon atoms, in which the carbon chain may be interrupted by heteroatoms, and
a is an integer from 1 to 8.

3. The process according to claim 1, wherein the at least one starter compound (A) is used alone or in any desired mixtures, and is selected from the group consisting of alcohols, polyetherols, and phenols.

4. The process according to claim 1, wherein a catalyst concentration of the double metal cyanide catalyst (B) is from >0 ppmw to 1000 ppmw, based on a total mass of the products (E) formed.

5. The process according to claim 1, wherein a reaction temperature is from 50° C. to 180° C, and/or wherein an internal pressure in the reactor is from 0.02 bar to 100 bar.

6. The process according to claim 1, wherein the cis-2,3-epoxy butane and trans-2,3-epoxy butane are simultaneously added as an isomer mixture to the a reaction mixture of the at least one starter compound (A) and the double metal cyanide catalyst (B).

7. The process according to claim 1, wherein the 2,3-epoxybutane (C) used is a mixture of trans-2,3-epoxybutane and cis-2,3-epoxybutane having a purity of >90% by weight.

8. The process according to claim 1, wherein the further epoxy monomers (D) used are selected from the group consisting of the alkylene oxides and glycidyl compounds.

9. The process according to claim 1, wherein less than 30% of the 2,3-epoxybutane monomers used are converted into unsaturated compounds by side reactions.

10. The process according to claim 1, wherein the starter used is a polyether (E) already prepared by the process.

11. The process according to claim 1, wherein the at least one polyether (E) based on the 2,3-epoxybutane (C) is reacted with the at least one endcapping reagent (F) to afford the at least one endcapped polyether (G) containing endcapped polyether residues, with the terminal hydroxy groups of the at least one polyether (E) reacting further to form ester, ether, urethane, and/or carbonate groups.

12. A polyether (E) of the formula (2) based on 2,3-epoxybutane (C), obtainable by the process according to claim 1, 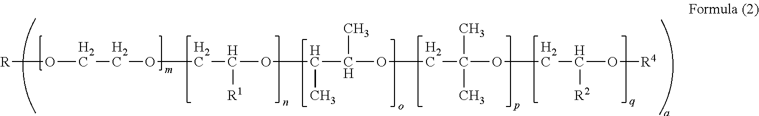
wherein
R is a saturated or unsaturated, linear or branched radical having 1 to 500 carbon atoms, in which the carbon chain may be interrupted by heteroatoms.
a is an integer from 1 to 8,
R¹ is in each case independently a monovalent hydrocarbon radical having 1 to 16 carbon atoms;
R² is a radical of the formula —CH₂—O—R³,
R³ is in each case independently a monovalent hydrocarbon radical having 3 to 18 carbon atoms;
R⁴ is in each case independently a monovalent organic radical having 1 to 18 carbon atoms or hydrogen,
m, n, p and q are each independently 0 to 300,
o is a number from 1 to 300,
with the proviso that a sum total of m, n, o, p, and q is greater than 1.

13. The polyether according to claim 12, wherein
R is an organic radical derived from allyl alcohol, allyloxyethanol, allyloxypropanol, methallyl alcohol, butanol, dipropylene glycol, glycerol, and/or polyetherols having 1-8 hydroxyl groups and molar masses of 50 to 5000 g/mol that had in turn been prepared by a prior alkoxylation.
R⁴ is in each case independently selected from the group consisting of monovalent hydrocarbon radicals having 1 to 18 carbon atoms, acyl radicals —C(═O)R⁵, urethane radicals —C(═O)NH—R⁶, carbonate radicals —C(═O)O—R⁷, and hydrogen; where the term “hydrogen” denotes a hydrogen radical,
R⁵ is in each case independently an alkyl or alkenyl radical having 1 to 18 carbon atoms,
R⁶ is in each case independently an alkyl or aryl radical having 1 to 18 carbon atoms, and/or
R⁷ is in each case independently an alkyl radical having 1 to 18 carbon atoms.

14. The polyether (E) according to claim 12, wherein the polyether contains per mole of the 2,3-epoxybutane (C) used less than 0.3 moles of C═C double bonds, not including C═C double bonds introduced into the polyether (E) by unsaturated starters of the at least one starter compound (A) or other unsaturated epoxy monomers of the further epoxy monomers (D).

15. The polyethers (E) according to claim 12, wherein the number-average molar mass Mₙ of the polyether (E) is from 200 g/mol to 30 000 g/mol, wherein the polydispersity (M_{w}/Mₙ) of the polyethers (E) is from 1.05 to 5, and wherein the number-average molar mass Mₙ, the weight-average molar mass M_{w}, and the polydispersity (M_{w}/Mₙ) are determined by gel-permeation chromatography (GPC)

16. The process according to claim 3, wherein the at least one starter compound (A) has a molar mass of 30 to 15,000 g/mol, and
wherein the at least one starter compound (A) is allyl alcohol, allyloxyethanol, allyloxypropanol, methallyl alcohol, butanol, a fatty alcohol having 8 to 20 carbon atoms, dipropylene glycol, glycerol, and/or a polyetherol having 1-8 hydroxyl groups and a molar mass of 50 to 5,000 g/mol that had in turn been prepared by a prior alkoxylation.

17. The process according to claim 4, wherein the double metal cyanide catalyst (B) is a zinc/cobalt DMC catalyst.

18. The process according to claim 6, wherein the isomer mixture consists of 10% to 95% of the trans-2,3-epoxybutane and 5% to 90% of the cis-2,3-epoxybutane, wherein a sum total of the trans-2,3-epoxybutane and the cis-2,3-epoxy butane adds up to 100% by weight.

19. The process according to claim 7, wherein a content of any C₄ hydrocarbons present in the mixture is at most <3% by weight, and wherein a content of other possible secondary components present in the mixture is at most <3% by weight.

20. The process according to claim 8, wherein the further epoxy monomers (D) are selected from the group consisting of phenyl glycidyl ether, o-cresyl glycidyl ether, tert-butylphenyl glycidyl ether, allyl glycidyl ether, butyl glycidyl ether, 2-ethylhexyl glycidyl ether, C₁₂/C₁₄ fatty alcohol glycidyl ether, and C₁₃/C₁₅ fatty alcohol glycidyl ether.
